(19) United States
(12) Patent Application Publication
(10) Pub. No.: US 2008/0313286 A1
(43) Pub. Date: Dec. 18, 2008

(54) SYSTEM FOR PROVIDING PRESENTATION VIA NETWORK

(76) Inventor: Robert Tsao, Taipei City (TW)

Correspondence Address: SCHMEISER, OLSEN & WATTS, 22 CENTURY HILL DRIVE, SUITE 302, LATHAM, NY, 12110, US

(21) Appl. No.: 11/763,473

(22) Filed: Jun. 15, 2007

(51) Int. Cl. G06F 15/16

(52) U.S. Cl. 709/206

(57) ABSTRACT

A system for providing presentation via network includes a computer system at a first end having a presentation image retrieval module that retrieves and convents presentation contents into a presentation image and transmits the presentation image to a first instant messaging module on the first computer system, and the presentation image is further transmitted via a network to a second instant messaging module on at least one computer system at a second end for showing on a display of the second computer system. Therefore, a presentation can be given without the need of gathering a presenter and many audiences at a specified place.

### FIELD OF THE INVENTION

The present invention relates to a system for providing presentation via network, and more particularly to a system that enables a presentation to be given via a network using a presentation image retrieval module and instant messaging modules.

### BACKGROUND OF THE INVENTION

Presentations are widely used in various occasions, such as teaching, forums, symposiums, and introduction of new products. Except for the product presentation that belongs to a service behavior, all other presentations have a common feature, that is, the presenters and the audiences have to meet at a specified place before the presentations can be given. FIG. 1 shows an application example of a conventional presentation system. As shown, to give a product presentation to customers 5, a sales representative 4 has to bring his product 3 and presentation materials 2 with him and take traffic means to the customer end 5. The presentation is delivered using a presentation system 1 available at the customer end 5, so as to introduce the product 3 to the customers 5. The whole process of product presentation in this manner is time and labor consuming and cost-ineffective.

It is therefore tried by the inventor to develop a system for providing presentation via network, so that a presentation may be given via a network and the presenter and the audiences of the presentation need not meet at a specified place.

### SUMMARY OF THE INVENTION

A primary object of the present invention is to provide a system for providing presentation via network, so that a presentation may be given by transmitting presentation image signals from a first computer system to a second computer system via a network without the need of gathering a presenter and many audiences.

To achieve the above and other objects, the system for providing presentation via network according to a preferred embodiment of the present invention includes a first computer system having a first computer and a first display, the first computer including a first instant messaging module and a presentation image retrieval module; and at least one second computer system having a second computer and a second display each, and each of the second computers including a second instant messaging module and being linked to the first computer via a network. The presentation image retrieval module converts an entire play process of a presentation into a presentation image, which is displayed on the first display via the first instant messaging module, and further transmitted to the second instant messaging module via the network for displaying on the second display.

With these arrangements, a presentation may be given via a network without the need of gathering the presenter and the audiences of the presentation at a specified place.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows an application example of a conventional presentation system; and

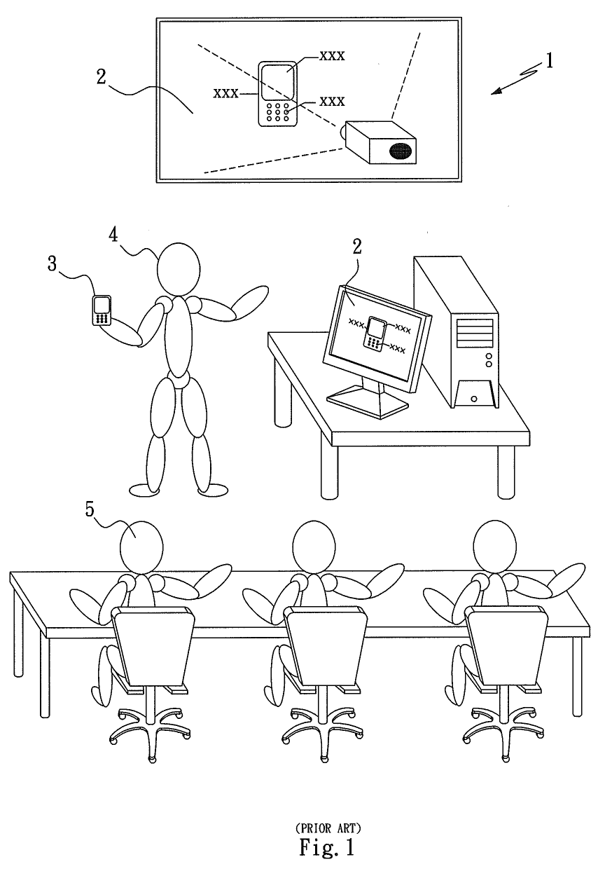

FIG. 2 shows the application of a system for providing presentation via network according to a preferred embodiment of the present invention.

### DETAILED DESCRIPTION OF THE PREFERRED EMBODIMENTS

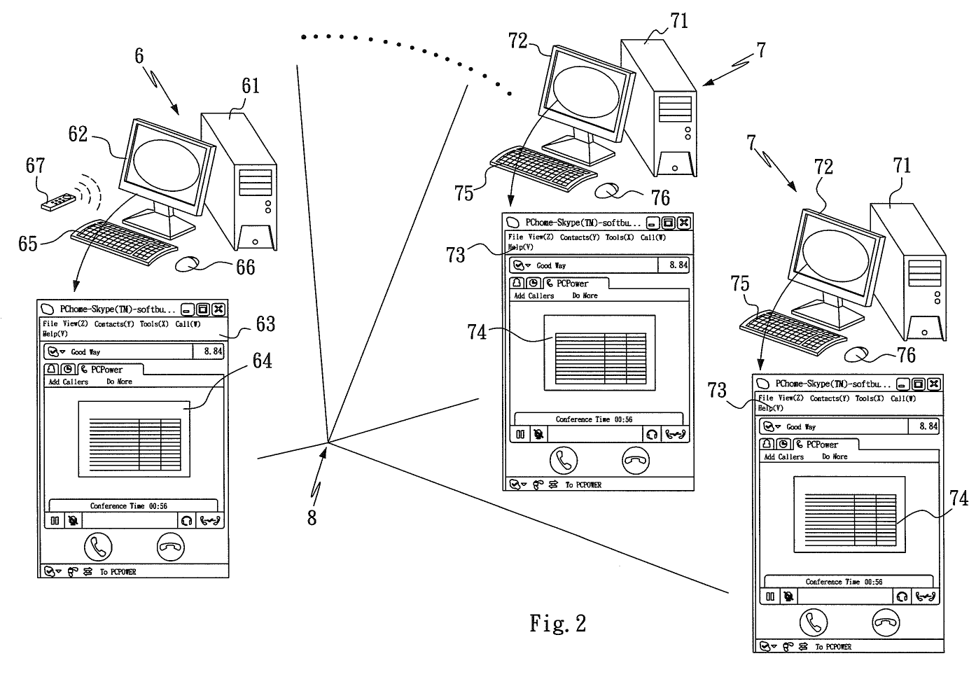

Please refer to FIG. 2 that shows an application of a system for providing presentation via network according to a preferred embodiment of the present invention. As shown, the system for providing presentation via network according to the present invention includes a first computer system 6, a network 8, and at least one second computer system 7.

The first computer system 6 may be any one of a desktop computer and a notebook computer, and includes a first computer 61 and a first display 62. The first computer 61 includes a first instant messaging module 63 and a presentation image retrieval module. The first display 62 may be any one of a traditional screen, a liquid crystal display (LCD), and a projector.

The second computer system 7 may be any one of a desktop computer and a notebook computer, and includes a second computer 71, a second display 72, a keyboard 75, and a mouse 76. The second computer 71 includes a second instant messaging module 73. The second display 72 may be anyone of a traditional screen, a liquid crystal display (LCD), and a projector. The second computer 71 is linked to the first computer 61 via the network 8.

When a presentation is to be provided by a presenter for at least one audience, the presenter may use the presentation image retrieval module in the first computer 61 to convert an entire play process of the presentation into a presentation image 64 for transmitting via the first instant messaging module 63, which may be SKYPE®, MSN®, QQ®, AIM®, Google Talk®, or Yahoo! Messenger®. In other words, the presentation image 64 is displayed on the first display 62 via the first instant messaging module 63, and is further transmitted to the second instant messaging module 73 in the second computer 71 via the network 8 to be displayed on the second display 72. Wherein, the presentation may be in the form of a presentation file, such as a PowerPoint file, a picture file, or an image file. The presenter may use a keyboard 65, a mouse 66, and/or a presentation device 67 of the first computer system 6 to control the play of the presentation, such as start, page up/down, stop, etc. The presenter using the first computer system 6 may also transmit his or her speech and image to the audiences using the second computer systems 7 via the first instant messaging module 63, the network 8, and the second instant messaging module 73, so as to introduce the presentation contents to the audiences.

As can be seen from the above description, the present invention is novel and improved because it allows image signals of the presentation to be transmitted via a network using a presentation image retrieval module and two or more instant messaging modules, so that the presentation can be given without the need of gathering the presenter and the audiences at a specified place. The present invention is also industrially practical and valuable because products derived there from would no doubt fully meet the existing market demands.

What is claimed is:

1. A system for providing presentation via network, comprising:
a first computer system having a first computer and a first display; the first computer including a first instant messaging module and a presentation image retrieval module; and
at least one second computer system having a second computer and a second display each; each of the second computers including a second instant messaging module and being linked to the first computer via a network; and
the presentation image retrieval module converting an entire play process of a presentation into a presentation image, which is displayed on the first display via the first instant messaging module, and further transmitted to the second instant messaging module via the network for displaying on the second display.

2. The system for providing presentation via network as claimed in claim 1, wherein the first computer system is selected from the group consisting of a desktop computer system and a notebook computer system.

3. The system for providing presentation via network as claimed in claim 1, wherein the first computer system further includes any one of a keyboard, a mouse, and a presentation device for controlling the play of the presentation.

4. The system for providing presentation via network as claimed in claim 1, wherein the first display is selected from the group consisting of a traditional screen, an LCD screen, and a projector.

5. The system for providing presentation via network as claimed in claim 1, wherein the first and the second instant messaging module for transmitting the presentation image are selected from the group consisting of a SKYPE®, an MSN®, a QQ®, an AIM®, a Google Talk®, and a Yahoo! Messenger®.

6. The system for providing presentation via network as claimed in claim 1, wherein the second computer system is selected from the group consisting of a desktop computer system and a notebook computer system.

7. The system for providing presentation via network as claimed in claim 1, wherein the second display is selected from the group consisting of a traditional screen, an LCD screen, and a projector.

8. The system for providing presentation via network as claimed in claim 1, wherein the presentation is a file selected from the group consisting of a presentation file, a picture file, and an image file.

9. The system for providing presentation via network as claimed in claim 1, wherein the first instant messaging module, the network, and the second instant messaging module transmit speech of a first user at the end of the first computer system introducing the presentation to a second user at the end of the second computer system.

10. The system for providing presentation via network as claimed in claim 1, wherein the first instant messaging module, the network, and the second instant messaging module transmit speech and image of a first user at the end of the first computer system introducing the presentation to a second user at the end of the second computer system.
